(19) United States
(12) Patent Application Publication
(10) Pub. No.: US 2012/0265509 A1
(43) Pub. Date: Oct. 18, 2012

(54) Aircraft Emulation System

(75) Inventors: David Sam Mier, Mercer Island, WA (US); Richard Bruce Butenko, Sammamish, WA (US); Kenneth Casimir Krzyzewski, Bellevue, WA (US); Timothy M. Mitchell, Seattle, WA (US)

(73) Assignee: THE BOEING COMPANY, Chicago, IL (US)

(21) Appl. No.: 13/267,527

(22) Filed: Oct. 6, 2011

Related U.S. Application Data
(60) Provisional application No. 61/391,469, filed on Oct. 8, 2010.

(51) Int. Cl. G06G 7/48

(52) U.S. Cl. 703/8

(57) ABSTRACT

A mobile aircraft emulation system comprising communications hardware and data processing hardware. The communications hardware is configured for use in an aircraft and to establish a communications link with an airport network data processing system. The data processing hardware is configured for use in the aircraft to run a number of software aircraft parts and exchange information with the airport network data processing system using the communications link. The number of software aircraft parts is configured for use in the aircraft.

### BACKGROUND INFORMATION

1. Field

The present disclosure relates generally to aircraft and, in particular, to aircraft network data processing systems. Still more particularly, the present disclosure relates to a method and apparatus for testing communications between aircraft network data processing systems and airport network data processing systems.

2. Background

Aircraft have become more and more sophisticated. Most aircraft have aircraft network data processing systems in which computers and other devices perform various functions during the operation of an aircraft. For example, an aircraft network data processing system may be used to perform navigation functions and may include auto-pilot functions. Further, these aircraft network data processing systems record and store events occurring during the operation of an aircraft.

Aircraft network data processing systems may communicate with other computers located off of an aircraft. For example, an aircraft network data processing system may exchange information with other computers or network data processing systems. This information may include, for example, without limitation, loss of events, data, programs, commands, files, images, and other types of information.

One location in which an aircraft may communicate with another network data processing system is at an airport. The airport may be a commercial airport for passengers, a maintenance location, and/or other suitable types of airports at which aircraft land and take off. At an airport, the aircraft may establish a communications link with an airport network data processing system. This communications link is typically a wireless communications link. One or more computers or other devices on the aircraft network data processing system may then exchange information with one or more computers or other devices in the airport network data processing system.

More and more information is exchanged between computers in aircraft and computers in the airport network data processing system. These communications are used to perform different functions. For example, an aircraft may download logs or other information when arriving at a terminal. As another example, the aircraft may receive software aircraft parts, instructions, notices to airmen (NOTAMs), routing information, and/or other types of information from the airport. This information may be generated by the airport, the airline, a regulatory agency, or other sources.

When new software and/or hardware are designed and manufactured for use in aircraft, testing of these components is performed to ensure that the components provide desired communication with computers in airport network data processing systems. The testing may include installing the new hardware and software in the aircraft. The aircraft is then flown to the airport. Tests of the new hardware and software are then performed. For example, testing may be performed to determine whether hardware and software in the aircraft result in desired communications with the airport network data processing system.

The use of the aircraft for testing at the airport may be more time consuming, difficult, and expensive than desired. For example, testing using an actual aircraft includes flying the aircraft to the particular airport. This type of testing requires the use of the aircraft, time, and fuel. Additionally, other resources, such as a flight crew to fly the aircraft to the airport for testing, are also necessary to test an aircraft at the airport. Further, when testing the aircraft at a terminal, other aircraft are unable to use the space in which the testing occurs.

Therefore, it would be advantageous to have a method and apparatus that takes into account at least some of the issues discussed above, as well as possibly other issues.

### SUMMARY

In one advantageous embodiment, a mobile aircraft emulation system comprises communications hardware and data processing hardware. The communications hardware is configured for use in an aircraft and to establish a communications link with an airport network data processing system. The data processing hardware is configured for use in the aircraft run a number of software aircraft parts and exchange information with the airport network data processing system using the communications link. The number of software aircraft parts is configured for use in the aircraft.

In another advantageous embodiment, a mobile communications testing system comprises a mobile platform, a structure carried by the mobile platform, an antenna, and a hardware system. The structure is positionable in an orientation substantially similar to when the structure is located on a vehicle. The antenna is connected to the structure such that the antenna has an orientation that substantially corresponds to a particular orientation of a corresponding antenna on the vehicle. The hardware system is configured for use in the vehicle and to establish a communications link with a network data processing system. The hardware system is further configured to emulate information of the vehicle with the network data processing system.

In yet another advantageous embodiment, a method for testing operations performed with an airport network data processing system is provided. A communications link is established between the airport network data processing system and a mobile aircraft emulation system. The mobile aircraft emulation system comprises hardware configured for use in an aircraft that is used for exchanging information with the airport network data processing system. Operations are performed using the communications link in which the operations emulate performance of the operations by the aircraft.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof will best be understood by reference to the following detailed description of an advantageous embodiment of the present disclosure when read in conjunction with the accompanying drawings, wherein:

FIG. 1 is an illustration of an aircraft communications environment in accordance with an advantageous embodiment;

FIG. 2 is an illustration of aircraft hardware in accordance with an advantageous embodiment;

FIG. 3 is an illustration of a hardware communications system in accordance with an advantageous embodiment;

FIG. 4 is an illustration of a testing system in accordance with an advantageous embodiment;

FIG. 5 is an illustration of components used to position an antenna in accordance with an advantageous embodiment;

FIG. 6 is an illustration of coverage areas in an airport in accordance with an advantageous embodiment;

FIG. 7 is an illustration of a mobile aircraft emulation system in accordance with an advantageous embodiment;

FIG. 8 is an illustration of hardware for a mobile aircraft simulation system in accordance with an advantageous embodiment;

FIG. 9 is an illustration of a flowchart of a process for testing connectivity to an airport network data processing system in accordance with an advantageous embodiment;

FIG. 10 is an illustration of a flowchart of a process for performing operations using a communications link in accordance with an advantageous embodiment;

FIG. 11 is an illustration of a flowchart of a process for performing a data transfer test in accordance with an advantageous embodiment; and

FIG. 12 is an illustration of a data processing system in accordance with an advantageous embodiment.

### DETAILED DESCRIPTION

The different advantageous embodiments recognize and take into account one or more different considerations. For example, the different advantageous embodiments recognize and take into account that another manner in which testing for devices may occur is through simulations in a laboratory. The different advantageous embodiments recognize and take into account that the aircraft and other components may be simulated along with the components for the airport network data processing system at the airport.

The use of simulators may reduce costs, difficulty, and time. The different advantageous embodiments recognize and take into account that these types of simulations, however, may not properly simulate all of the different conditions that may occur when an aircraft communicates with an airport.

The different advantageous embodiments also recognize and take into account that simulation software may be placed on a laptop or other portable computer and taken to an airport for testing. The different advantageous embodiments recognize and take into account, however, that this type of testing may have limited connectivity with the airport network data processing system. The speed or bandwidth for a communications link may be different using a laptop as compared to the aircraft itself. The different advantageous embodiments recognize and take into account that the laptop does not use the same hardware as the aircraft for exchanging information. For example, features such as certificates used to establish communications links, actual software, or aircraft parts may not be used on the laptop. Simulating the functions using a laptop may not result in the laptop performing in the same manner as the aircraft.

For example, the different advantageous embodiments recognize and take into account that simulations in a laboratory and those using a laptop at the airport often do not sufficiently take into account factors such as the antenna for the aircraft. The antenna, the position and the structure on which the antenna is located, and other factors may affect the establishment of a communications link.

Thus, the advantageous embodiments provide a method for emulating an aircraft. In one advantageous embodiment, a mobile aircraft emulation system comprises communications hardware, a number of software aircraft parts, and data processing hardware. The communications hardware is configured for use in an aircraft. The communications hardware is configured to establish a communications link with an airport network data processing system. The data processing hardware is configured for use in the aircraft and configured to run the number of software aircraft parts and exchange information with the airport network data processing system using the communications link.

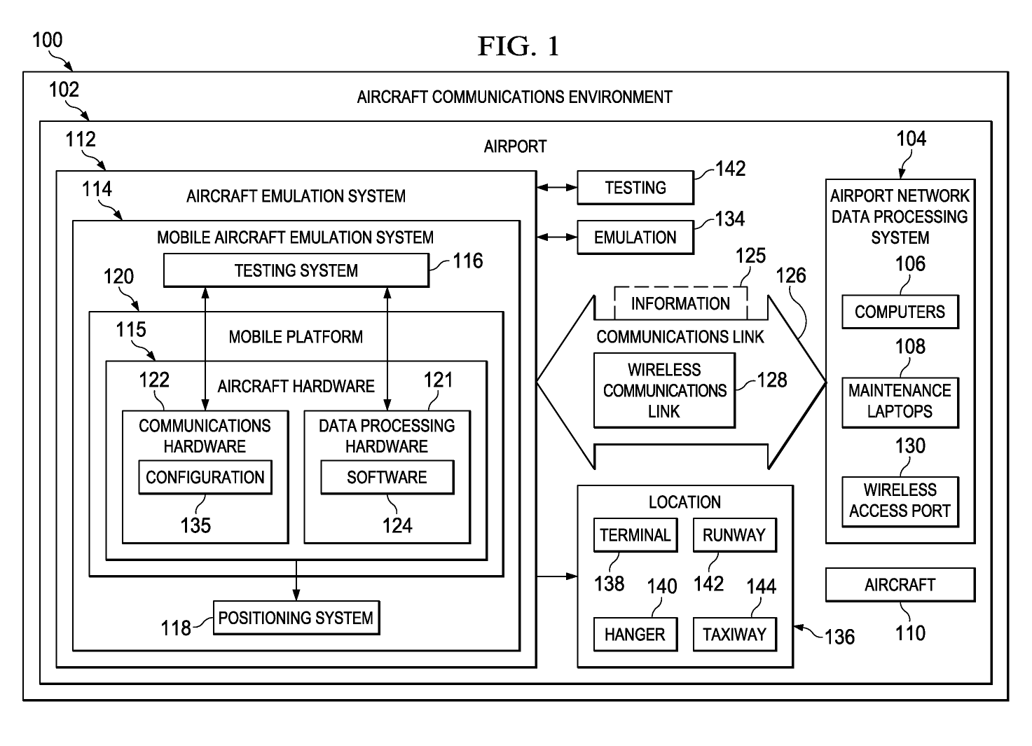

With reference now to the figures and, in particular, with reference now to FIG. 1, an illustration of an aircraft communications environment is depicted in accordance with an advantageous embodiment. In this illustrative example, airport 102 is part of aircraft communications environment 100. Airport 102 has airport network data processing system 104. Airport network data processing system 104 is comprised of computers 106 that are in communication with each other. Further, one or more of maintenance laptops 108 also may be part of airport network data processing system 104. Aircraft 110 at airport 102 may communicate with airport network data processing system 104 to perform various functions.

Communications between aircraft 110 and airport network data processing system 104 may be used for different purposes. For example, maintenance log downloads communication between ground users and the aircraft, data uploads, flight plan updates, reports, and other types of data being exchanged. These communications may have a number of different benefits. For example, these communications may be used to coordinate various operations at airport 102. These operations may include, for example, without limitation, baggage handling, surface vehicle tracking, security operations, and other suitable types of operations.

When aircraft 110 is a new aircraft or if modifications are made to aircraft 110, testing aircraft 110 is desirable to determine whether aircraft 110 is able to communicate with airport network data processing system 104 in a desired manner. This testing is performed to enable efficient operations at airport 102, in aircraft 110, or a combination of the two.

In these illustrative examples, moving aircraft 110 to airport 102 may be unnecessary to perform tests of aircraft 110. The need for aircraft 110 may be avoided with the use of aircraft emulation system 112. In the illustrative examples, aircraft emulation system 112 is located at airport 102.

As depicted, aircraft emulation system 112 takes the form of mobile aircraft emulation system 114. Mobile aircraft emulation system 114 comprises aircraft hardware 115, testing system 116, and positioning system 118.

Aircraft hardware 115 is hardware that is configured for use in aircraft 110. In other words, aircraft hardware 115 is hardware that is intended for use in aircraft 110 or is actually used in aircraft 110.

In these depicted examples, aircraft hardware 115 comprises data processing hardware 121 and communications hardware 122. Data processing hardware 121 is hardware configured for use in aircraft 110. Data processing hardware 121 is configured to run software 124.

Software 124 is software configured for use in aircraft 110. In other words, software 124 is software that is intended for use in aircraft 110.

Data processing hardware 121 is configured to exchange information 125 with components in airport network data processing system 104 using communications link 126. Communications link 126 takes the form of wireless communications link 128 in these illustrative examples.

Communications hardware 122 is configured for use in aircraft 110 and is configured to establish wireless communications link 128 with airport network data processing system 104. Communications hardware 122 establishes wireless communications link 128 with wireless access port 130 in airport network data processing system 104. In these illustrative examples, data processing hardware 121 exchanges information 125 with airport network data processing system 104.

Testing system 116 is configured to operate at least one of aircraft hardware 115, software 124, and other suitable components. In these illustrative examples, testing system 116 is hardware, software, or a combination of the two.

As used herein, the phrase “at least one of”, when used with a list of items, means different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C.

In the illustrative examples, testing system 116 in aircraft emulation system 112 controls the operation of at least one of aircraft hardware 115, software 124, and other suitable components to perform emulation 134 of aircraft 110 at airport 102. Emulation 134 may be performed without needing use of aircraft 110 or moving aircraft 110 to airport 102.

Positioning system 118 is configured to position at least a portion of communications hardware 122 in configuration 135. Configuration 135 corresponds to a configuration of communications hardware 122 that would be present on aircraft 110 in actual or intended use.

In this illustrative example, configuration 135 is a position of communications hardware 122. In particular, the position may be that of communications hardware 122. In other illustrative examples, configuration 135 may be the position of the hardware on aircraft 110. The position may be, for example, a height and orientation of communications hardware 122 that substantially corresponds to the height and orientation of communications hardware 122 when communications hardware 122 is on aircraft 110. For example, configuration 135 may be a position of an antenna that substantially corresponds to the position of the antenna on aircraft 110 when aircraft 110 establishes communications link 126 with airport network data processing system 104.

For example, the position may include a position of an antenna in communications hardware 122. The position substantially corresponds to a particular position of a corresponding antenna on aircraft 110. A corresponding antenna is an antenna that is the same antenna as the antenna in communications hardware 122. In other words, the antenna in communications hardware 122 may have substantially the same materials, dimensions, and other attributes as the corresponding antenna on aircraft 110.

At least one of aircraft hardware 115, testing system 116, and positioning system 118 is associated with mobile platform 120. Mobile platform 120 is configured to carry these components. Mobile platform 120 may take a number of different forms. For example, mobile platform 120 may be a vehicle, a cart, a truck, a suitcase, or some other suitable platform.

The association is a physical association in these depicted examples. A first component, aircraft hardware 115, may be considered to be associated with a second component, mobile platform 120, by being secured to the second component, bonded to the second component, mounted to the second component, welded to the second component, fastened to the second component, and/or connected to the second component in some other suitable manner. The first component also may be connected to the second component using a third component. The first component may also be considered to be associated with the second component by being formed as part of, and/or an extension of, the second component. As another example, the first component may be associated with the second component by being carried by the second component.

In this manner, mobile aircraft emulation system 114 may be moved to location 136 in airport 102 to perform testing or exchange of information 125 with airport network data processing system 104. Location 136 may be, for example, a location at airport 102 such as terminal 138, hanger 140, runway 142, taxiway 144, and/or some other suitable location. Location 136 may even be in the air, such as a location on an approach route or airspace around airport 102.

In this manner, mobile aircraft emulation system 114 may perform emulation 134 of aircraft 110 in location 136. Emulation 134 may test the ability of aircraft 110 to exchange information 125 with airport network data processing system 104. In particular, emulation 134 of aircraft 110 using mobile aircraft emulation system 114 may be used to perform testing of at least one of aircraft 110 and airport network data processing system 104.

Testing 142 may be performed to determine whether changes to aircraft 110 or the design of aircraft 110 provide a desired level of exchange of information 125 with airport network data processing system 104. Additionally, changes to airport network data processing system 104 may be tested to determine whether those changes are compatible with aircraft 110. Also, security of at least one of airport network data processing system 104 and aircraft 110 may be performed.

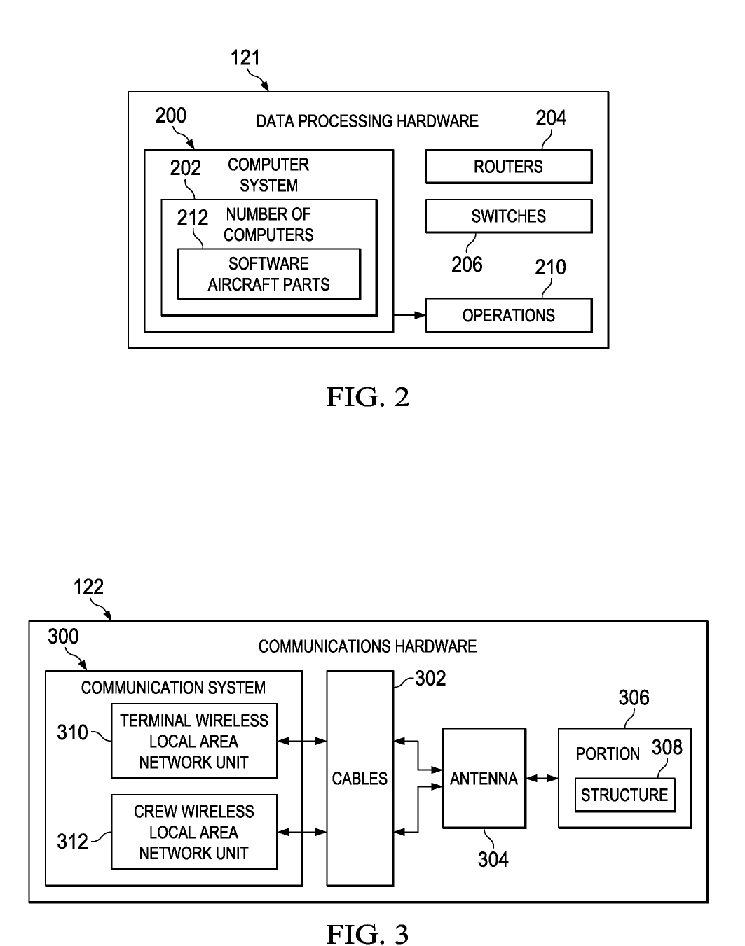

With reference next to FIG. 2, an illustration of aircraft hardware is depicted in accordance with an advantageous embodiment. In this illustrative example, data processing hardware 121 includes computer system 200. Computer system 200 comprises number of computers 202. “A number”, as used herein with reference to items, means one or more items. For example, “number of computers 202” is one or more computers.

In these illustrative examples, data processing hardware 121 may include other types of hardware in addition to and/or in place of computer system 200. For example, a circuit system, application specific integrated circuits, programmable logic devices, and/or other suitable types of hardware may be present in aircraft hardware 115 that may be configured for use in aircraft 110 shown in block form in FIG. 1. As another example, data processing hardware 121 also may include routers 204, switches 206, and/or other components that may provide for communication between computers in number of computers 202 in computer system 200.

Computer system 200 is configured to perform operations 210. Operations 210 are performed using software aircraft parts 212. Software aircraft parts 212 are examples of software 124 in FIG. 1.

Software aircraft parts 212 are software aircraft parts that are configured for use in aircraft 110. In being configured for use with aircraft 110, these components are the actual components that may be used in aircraft 110.

Software aircraft parts 212 may include various software aircraft parts that may be found on aircraft 110. In these illustrative examples, software aircraft parts 212 may include an onboard maintenance system application, a time manager application, a network server crossover interface, a flight-input data-output function, an onboard data load function, an electronic flight bag data manager, a terminal wireless local area network unit gate link authenticator, a wireless uplink and downlink diagnostics manager, a health manager, an onboard maintenance system, a support and maintenance system manager, a flight-input data-output diagnostic manager, and/or a time manager.

Operations 210 may include at least one of sending data, receiving data, authenticating with airport network data processing system 104, communicating with a maintenance laptop in maintenance laptops 108, loading software aircraft parts 212, configuring parameters to test software aircraft part functionality, and other suitable operations.

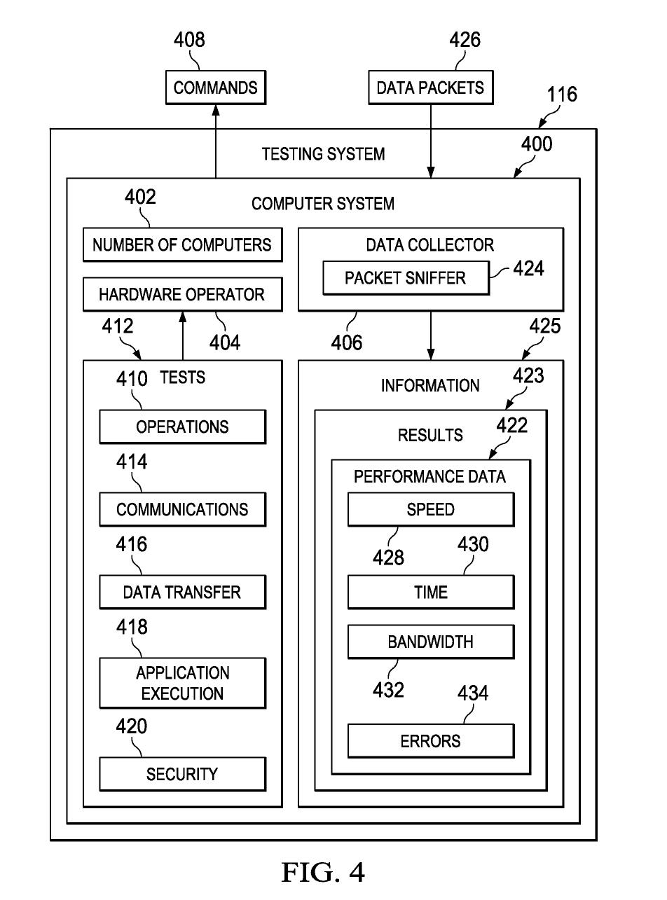

With reference now to FIG. 3, an illustration of a hardware communications system is depicted in accordance with an advantageous embodiment. In this illustrative example, one implementation for communications hardware 122 shown in block form in FIG. 1 is depicted.

In this particular example, communications hardware 122 comprises communication system 300, cables 302, antenna 304, portion 306 of structure 308, and other suitable components.

Communications hardware 122 comprises hardware used to facilitate communications for data processing hardware 121 over wireless communications link 128 in FIG. 1. In this illustrative example, communication system 300 comprises at least one of terminal wireless local area network unit (TWLU) 310 and crew wireless local area network unit (CWLU) 312.

Terminal wireless local area network unit 310 is a hardware component that is configured to communicate with airport network data processing system 104 in FIG. 1. In these illustrative examples, this component functions as a wireless access bridge between aircraft hardware 115 and airport network data processing system 104. This component may be used for functions such as “gate link” functions.

Terminal wireless local area network unit 310 may also receive uplink data from computers 106 in airport network data processing system 104. The uplink data may include, for example, without limitation, loadable software airplane parts and airplane modifiable information.

Terminal wireless local area network unit 310 also may send downlink data to computers 106 in airport network data processing system 104. This downlink data may include, for example, aircraft log files, certificate signing requests, engine data, and other suitable information.

Crew wireless local area network unit 312 acts as a wireless access bridge between aircraft hardware 115 and airport network data processing system 104. This component may be used in establishing communications link 126 with computer systems in airport network data processing system 104 used for maintenance operations at airport 102.

Crew wireless local area network unit 312 also may be used to load software airplane parts and airplane modifiable information. This component may be used to send and receive the same data as terminal wireless local area network unit 310 with maintenance laptops 108 in airport network data processing system 104.

Cables 302 are cables that connect components to each other. For example, cables 302 connect terminal wireless local area network unit 310 and crew wireless local area network unit 312 to antenna 304. Cables 302 also connect terminal wireless local area network unit 310 and crew wireless local area network unit 312 to data processing hardware 121 (not shown) in FIG. 1.

Antenna 304 is an antenna that is configured to be used in aircraft 110. Structure 308 is a structure on which antenna 304 is mounted on aircraft 110.

Structure 308 is used when structure 308 affects the performance of antenna 304. For example, if antenna 304 is a monopole antenna, the absence of structure 308 may affect performance of antenna 304. In these examples, only portion 306 of structure 308 that affects the performance of antenna 304 may be needed in communications hardware 122. Structure 308 may be, for example, a skin panel, a faring, or some other suitable type of structure.

With reference now to FIG. 4, an illustration of a testing system is depicted in accordance with an advantageous embodiment. An illustration of components that may be used to implement testing system 116 shown in block form in FIG. 1 is depicted. Testing system 116 may be implemented using computer system 400. Computer system 400 may comprise number of computers 402.

Hardware operator 404 and data collector 406 may be implemented in computer system 400. These two components may be implemented using hardware, software, or a combination of the two.

Hardware operator 404 is configured to operate aircraft hardware 115 in FIG. 1. For example, hardware operator 404 may send commands 408 to data processing hardware 121 in FIG. 1. In particular, hardware operator 404 may identify operations 410 to be performed by data processing hardware 121. Operations 410 may be performed for tests 412. Operations 410 may include operations 210 shown in block form in FIG. 2.

Tests 412 are configured to test the performance of aircraft hardware 115. In particular, the performance of aircraft hardware 115 may be tested with respect to establishing wireless communications link 128 and exchanging information 125 using wireless communications link 128 in FIG. 1. Additionally, tests 412 also may include tests to identify how well data processing hardware 121 processes information 125.

These tests may include, for example, without limitation, at least one of tests for communications 414, data transfer 416, application execution 418, security 420, and other suitable types of tests. Communications 414 may test the ability of aircraft hardware 115 to establish wireless communications link 128 with airport network data processing system 104. This test, for example, without limitation, includes contacting wireless access port 130, authenticating aircraft hardware 115 with airport network data processing system 104, and other suitable types of operations.

Data transfer 416 may test the ability of aircraft hardware 115 to transfer information 125 over wireless communications link 128. This transfer may include downloading data, uploading data, or a combination of the two. This test may include data transfers such as flight data downloading, maintenance downloading, chart updates, aircraft documentation uploads, pre-flight data uplinking, downloading engine trending information, video server uploads, in-flight entertainment content uploads, fuel data transfer, software aircraft part uploads, voice over internet protocol (VoIP) communications, point of sale transactions, and other suitable types of data transfers.

Application execution 418 may test the execution of software aircraft parts 212 by data processing hardware 121 in aircraft hardware 115. For example, application execution 418 may be used to determine whether software aircraft parts 212 perform as desired when information 125 is exchanged with airport network data processing system 104.

Security 420 may be used to test the security of aircraft hardware 115 in aircraft 110, airport network data processing system 104 at airport 102, or a combination of the two. Security 420 may be used to determine whether security issues are present in establishing wireless communications link 128 and during transfer of information 125 between aircraft hardware 115 and airport network data processing system 104. For example, this test may determine whether security keys or certificates become vulnerable during establishment of wireless communications link 128, transfer of information 125, or a combination of the two. Further, security 420 may be used to determine whether encryption of information 125 by at least one of aircraft hardware 115 and airport network data processing system 104 meets desired standards for encrypting data.

Data collector 406 may collect performance data 422. In these illustrative examples, performance data 422 may be results 423 from performing tests 412.

Performance data 422 may be obtained during performance of tests 412. In these illustrative examples, data collector 406 collects performance data 422 in a passive manner. In other words, additional code or instructions are not included in software aircraft parts 212 in an effort to reduce increases in time and other types of perturbations that may occur from altering software aircraft parts 212. For example, without limitation, data collector 406 may be implemented using a packet sniffer 424 that examines data packets 426 in information 425.

Performance data 422 may include, for example, at least one of speed 428, time 430, bandwidth 432, errors 434, and other suitable types of metrics used to identify the performance of aircraft hardware 115, software aircraft parts 212, and other suitable components. Speed 428 may be the speed at which information 425 is transferred over wireless communications link 128. Time 430 may be the time that software aircraft parts 212 takes to perform different operations.

Bandwidth 432 may identify the amount of bandwidth used to transfer information 125. Errors 434 may identify errors that occur during performance of operations 410. Errors 434 may include errors in at least one of error in transferring information 125, performing operations using software aircraft parts 212, and other suitable types of errors.

For example, performance data 422 also may include data about the performance of airport network data processing system 104.

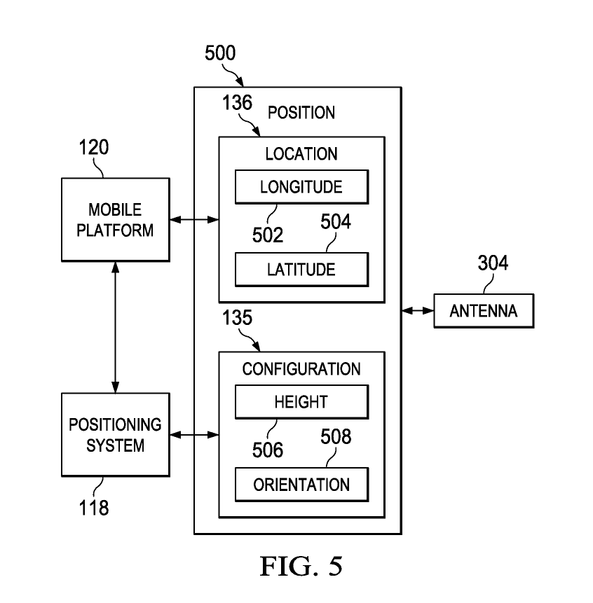

With reference now to FIG. 5, an illustration of components used to position an antenna is depicted in accordance with an advantageous embodiment. Antenna 304 is placed into position 500, mobile platform 120, and positioning system 118. Mobile platform 120 places antenna 304 shown in block form in FIG. 3 in location 136 at airport 102 shown in block form in FIG. 1. Positioning system 118 positions antenna 304 into configuration 135.

Position 500 comprises location 136 and configuration 135. As depicted, location 136 is described using longitude 502 and latitude 504. In this illustrative example, configuration 135 of antenna 304 includes height 506 and orientation 508. Height 506 is substantially the same height as when antenna 304 is used on aircraft 110. Orientation 508 is substantially the same orientation for a corresponding antenna to antenna 304 used on aircraft 110. In other words, antenna 304 is positionable, such as in orientation 508, which is substantially similar when antenna 304 is used on aircraft 110.

The illustration of aircraft communications environment 100 and example implementations for different components in FIGS. 1-5 are not meant to imply a physical or architectural limitation to the manner in which an advantageous embodiment may be implemented. Other components in addition to and/or in place of the ones illustrated may be used. Some components may be unnecessary. Also, the blocks are presented to illustrate some functional components. One or more of these blocks may be combined and/or divided into different blocks when implemented in an advantageous embodiment.

For example, in other illustrative examples, communications hardware 122 may include one or more antennas in addition to antenna 304. In still other illustrative examples, one or more of the different advantageous embodiments may be applied to communications environments other than aircraft communications environment 100. For example, one or more of the different advantageous embodiments may be applied to a vehicle communications environment for other types of vehicles instead of aircraft 110. For example, the different advantageous embodiments may be applied to vehicles such as a surface ship, a tank, a personnel carrier, a train, a spacecraft, a submarine, a bus, an automobile, and other suitable types of vehicles.

The infrastructure to which the vehicle communicates may be to an infrastructure other than airport 102 with airport network data processing system 104. For example, with a train, communications may be tested between a train and a train station. For a surface ship, communications may be tested between the surface ship and a port or dock area.

As another example, the illustration of the components in testing system 116 is not meant to limit the manner in which testing system 116 may be implemented. For example, other types of tests may be used in addition to and/or in place of the ones depicted in tests 412. For example, tests 412 may include performance tests for data processing hardware 121, software aircraft parts 212, or a combination of the two.

When an aircraft is designed to communicate with an airport network data processing system, determining whether the aircraft can communicate with the airport network data processing system in a desired manner within coverage areas is desirable. For example, coverage areas may include terminals, hangers, tarmacs, taxiways, and other locations.

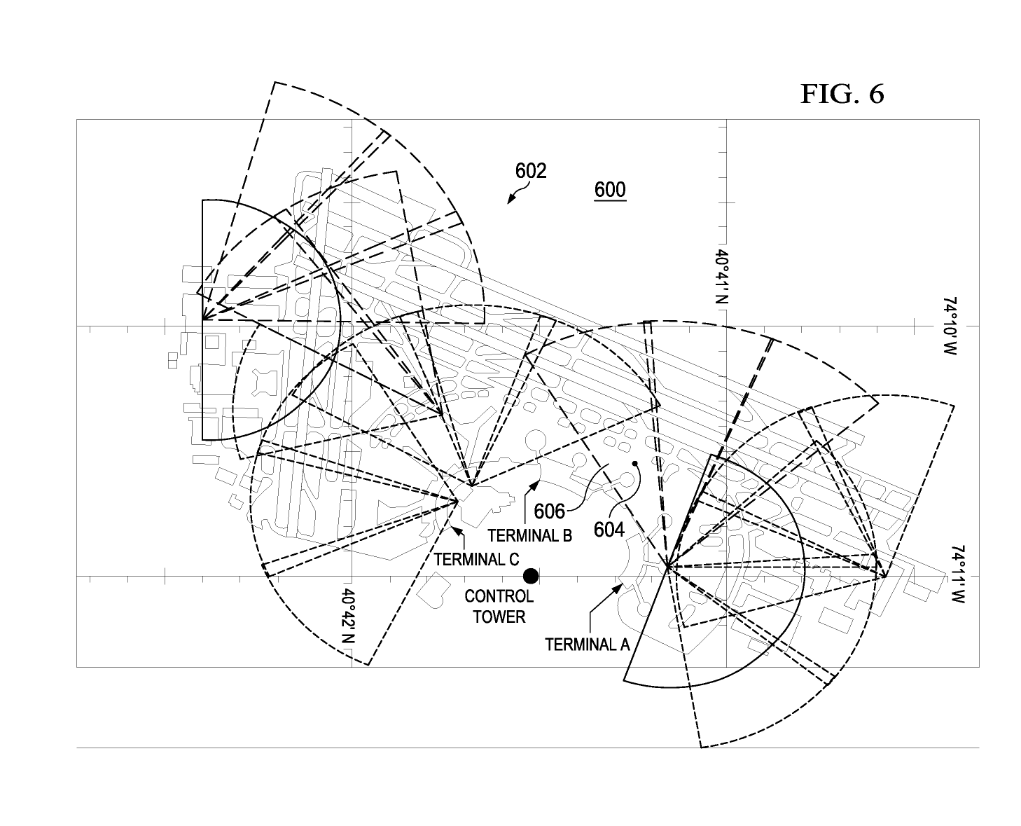

With reference now to FIG. 6, an illustration of coverage areas in an airport is depicted in accordance with an advantageous embodiment. In this illustrative example, airport 600 is an example of an implementation for airport 102 shown in block form in FIG. 1. In this illustrative example, coverage areas 602 are illustrated for airport 600. Coverage areas 602 are areas in which an aircraft may establish a communications link with an airport network data processing system, such as airport network data processing system 104, at airport 600.

In these illustrative examples, testing of communications with the airport network data processing system in these different coverage areas may be performed without needing an actual aircraft.

For example, an aircraft emulation system, such as aircraft emulation system 112, may be moved to location 604. At location 604, aircraft emulation system 112 should be able to communicate with the airport network data processing system for airport 600 in a desired manner within coverage area 606. With an aircraft emulation system in accordance with an advantageous embodiment, various tests may be performed to emulate the aircraft at location 604 without needing the use of an aircraft.

Further, moving the aircraft emulation system to different locations for other coverage areas in coverage areas 602 may be more easily performed as compared to using an actual aircraft. In this manner, testing of an ability to establish communications links may be made to determine whether a particular aircraft is able to communicate with the airport network data processing system at airport 600 in different locations at airport 600.

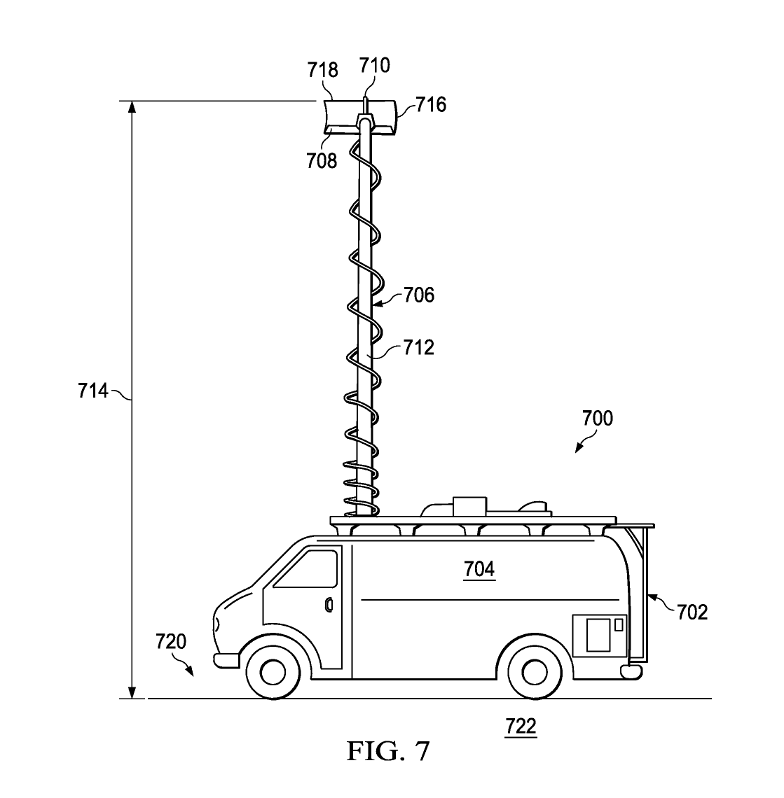

Turning now to FIG. 7, an illustration of a mobile aircraft emulation system is depicted in accordance with an advantageous embodiment. In this illustrative example, mobile aircraft emulation system 700 is an example of one implementation for mobile aircraft emulation system 114 shown in block form in FIG. 1.

In this depicted example, mobile aircraft emulation system 700 comprises mobile platform 702. Mobile platform 702 takes the form of vehicle 704 in this depicted example. Data processing hardware and some communications hardware are located inside of vehicle 704. In this illustrative example, a portion of the communications hardware is attached to the exterior of vehicle 704. In this illustrative example, configuration 706 and structure 708 with antenna 710 are located outside of vehicle 704. Configuration 706 takes the form of mast 712.

Mast 712 is an extendable mast that may extend and retract to change height 714 of antenna 710. In these illustrative examples, antenna 710 and structure 708 are in position 716. Position 716 corresponds to a position of antenna 710 on structure 708 when used on an aircraft. In these illustrative examples, the position includes height 714 and orientation 718.

In these illustrative examples, mobile aircraft emulation system 700 is at location 720 at airport 722. In this manner, position 716 also includes location 720.

In this manner, emulation of the aircraft may be more accurate with the use of the actual antenna and the structure to which the antenna is connected to on the aircraft. Further, with height 714, location 720, and orientation 718, emulation of the aircraft may be more accurately made.

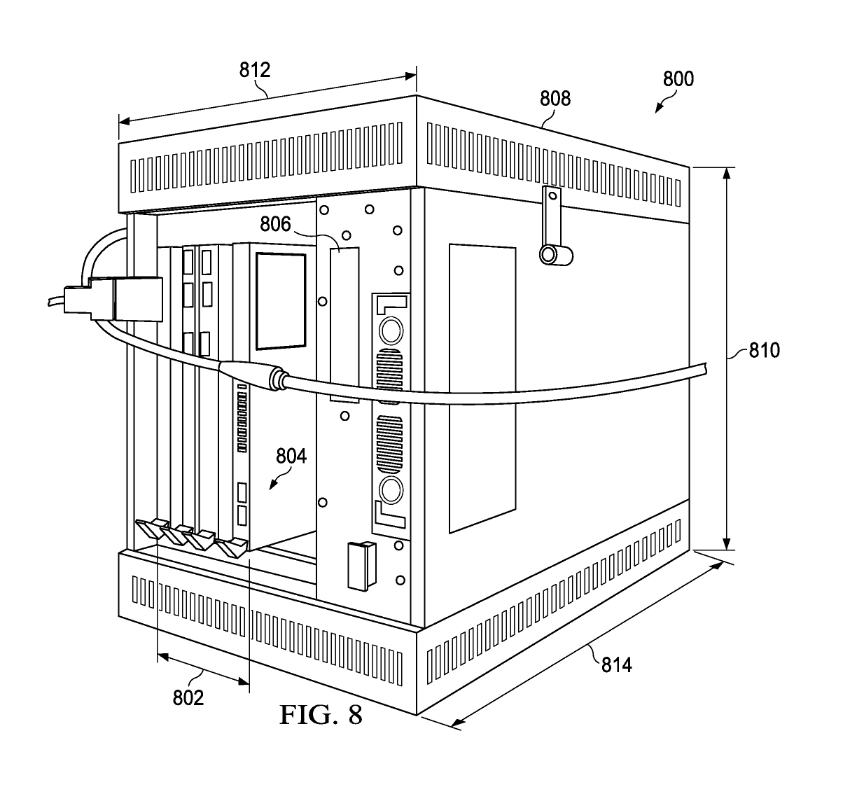

Turning next to FIG. 8, an illustration of hardware for a mobile aircraft simulation system is depicted in accordance with an advantageous embodiment. Hardware 800 is an example of aircraft hardware 115 shown in block form in FIG. 1. Hardware 800 is an example of hardware that may be used in mobile aircraft emulation system 700 in FIG. 7. In particular, hardware 800 may be located inside mobile platform 702 in FIG. 7 in this illustrative example. In this illustrative example, hardware 800 comprises data processing hardware 802, testing system 804, and communications system 806.

These components are located in frame 808. In this illustrative example, frame 808 has height 810, width 812, and depth 814. Height 810 is about 12 inches, width 812 is about 16 inches, and depth 814 is about 18 inches. Frame 808 may be placed inside of vehicle 704 in FIG. 7.

The different components illustrated in FIGS. 7 and 8 may be combined with components in FIGS. 1-5, used with components in FIGS. 1-5, or a combination of the two. Additionally, some of the components in these figures may be illustrative examples of how components shown in block form in FIGS. 1-5 may be implemented as physical structures.

Further, the illustration of components in these figures are not meant to imply limitations to the manner in which other advantageous embodiments may be implemented. For example, in some advantageous embodiments, the mobile platform may be a cart with a mast. In still other advantageous embodiments, the mobile platform may be a suitcase and the configuration may be moved independently of the suitcase.

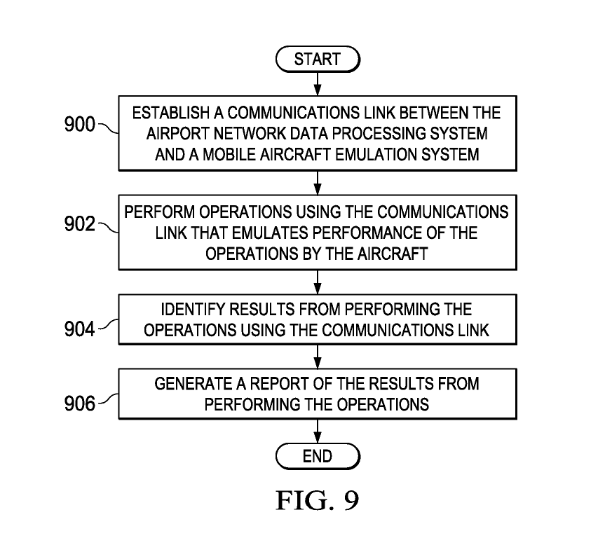

With reference now to FIG. 9, an illustration of a flowchart of a process for testing connectivity to an airport network data processing system is depicted in accordance with an advantageous embodiment. The process illustrated in FIG. 9 may be implemented in aircraft communications environment 100 in FIG. 1. These different operations may be performed using hardware such as the hardware components found in aircraft emulation system 112 shown in block form in FIG. 1.

The process begins by establishing a communications link between the airport network data processing system and a mobile aircraft emulation system (operation 900). The mobile aircraft emulation system may be mobile aircraft emulation system 114 in FIG. 1. The process then performs operations using the communications link that emulates performance of the operations by the aircraft (operation 902). These operations may be operations 410 performed for one or more of tests 412 shown in block form in FIG. 4. The process then identifies results from performing the operations using the communications link (operation 904). The process then generates a report of the results from performing the operations (operation 906), with the process terminating thereafter.

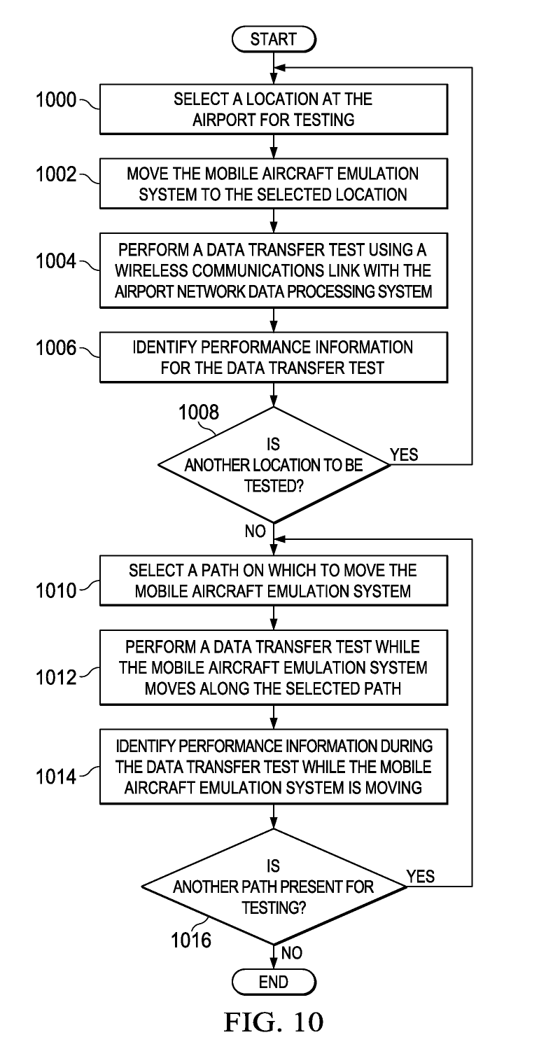

Turning next to FIG. 10, an illustration of a flowchart of a process for performing operations using a communications link is depicted in accordance with an advantageous embodiment. In this illustrative example, the different operations in FIG. 10 may be an example of an implementation for operation 902 in FIG. 9.

The process begins by selecting a location at the airport for testing (operation 1000). This location may be, for example, without limitation, a gate, a hanger, a runway, a maintenance facility, a taxiway, or some other suitable location at which a communications link should be established with an airport network data processing system. The process then moves the mobile aircraft emulation system to the selected location (operation 1002).

The process then performs a data transfer test using a wireless communications link with the airport network data processing system (operation 1004). The process identifies performance information for the data transfer test (operation 1006). The performance information includes any information that may be used in determining whether the operations have been performed in a desired manner. The performance information may include, for example, at least one of data transfer rates, file transfer times, bandwidth usage, errors, and other suitable parameters.

The process then determines whether another location is to be tested (operation 1008). If another location is to be tested, the process returns to operation 1000.

Otherwise, the process selects a path on which to move the mobile aircraft emulation system (operation 1010). This path may be, for example, a path taken by an aircraft when moving from a runway to a gate, a path taken by an aircraft to move to a hanger or maintenance facility, or some other suitable path. The process then performs a data transfer test while the mobile aircraft emulation system moves along the selected path (operation 1012).

The process identifies performance information during the data transfer test while the mobile aircraft emulation system is moving (operation 1014). Thereafter, a determination is made as to whether another path is present for testing (operation 1016). If another path is present, the process returns to operation 1010. Otherwise, the process terminates.

With the performance information generated in operation 1006 and operation 1014, an analysis may be made as to whether the communications operations have been performed at a desired level. With this analysis, adjustments or changes to at least one of aircraft hardware 115, software 124, and airport network data processing system 104 shown in block form in FIG. 1 may be identified if the communications operations are not performed at a desired level.

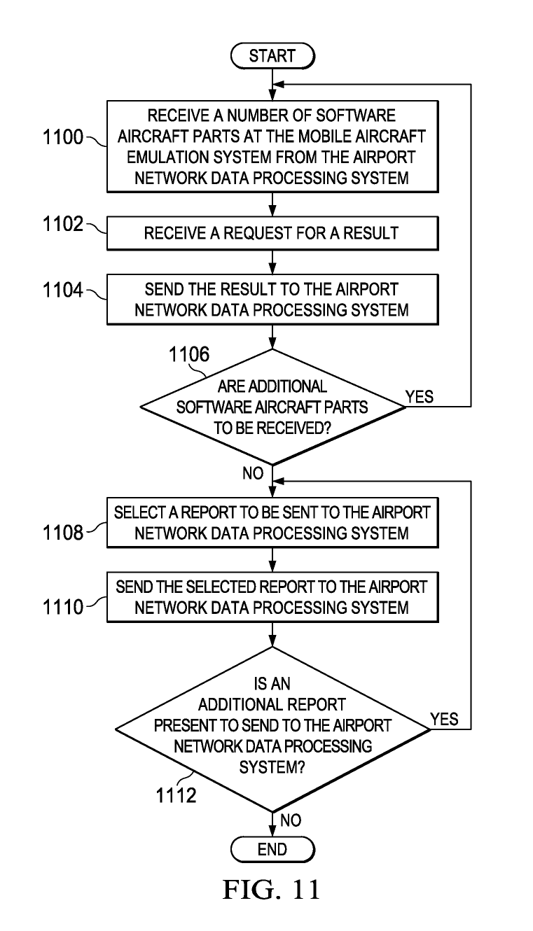

Turning now to FIG. 11, an illustration of a flowchart of a process for performing a data transfer test is depicted in accordance with an advantageous embodiment. The operations illustrated in FIG. 11 are an example of one manner in which the data transfer test in operation 1004 and in operation 1012 may be performed. These operations may be performed using testing system 116 shown in block form in FIG. 1. Alternatively, this process also may be performed by airport network data processing system 104.

The process begins by receiving a number of software aircraft parts at the mobile aircraft emulation system from the airport network data processing system (operation 1100). In these illustrative examples, the software aircraft parts are software aircraft parts that are configured for use by the aircraft hardware for the aircraft that is emulated by the mobile aircraft emulation system. The process then receives a request for a result (operation 1102). The result may be, for example, a configuration report regarding the processing of the software aircraft parts. The result also may include a log or any other suitable information. The process then sends the result to the airport network data processing system (operation 1104).

A determination is made as to whether additional software aircraft parts are to be received (operation 1106). If additional software parts to be received, the process returns to operation 1100.

Otherwise, the process selects a report to be sent to the airport network data processing system (operation 1108). The process sends the selected report to the airport network data processing system (operation 1110). This report may be, for example, a log or some other test file containing information that may be sent when an aircraft communicates with the airport network data processing system. A determination is made as to whether an additional report is present to send to the airport network data processing system (operation 1112). If an additional report is present, the process returns to operation 1108. Otherwise, the process terminates.

The illustration of operations for a data transfer test in FIG. 11 is only meant to be an example of one manner in which a data transfer test may be implemented. In the illustrative examples, a data transfer test is selected to emulate the type of data transfer that occurs during communication operations between an aircraft and an airport network data processing system. Other types of data transfer tests may be used depending on the particular implementation.

The flowcharts and block diagrams in the different depicted embodiments illustrate the architecture, functionality, and operation of some possible implementations of apparatuses and methods in an advantageous embodiment. In this regard, each block in the flowcharts or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some alternative implementations of an advantageous embodiment, the function or functions noted in the block may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

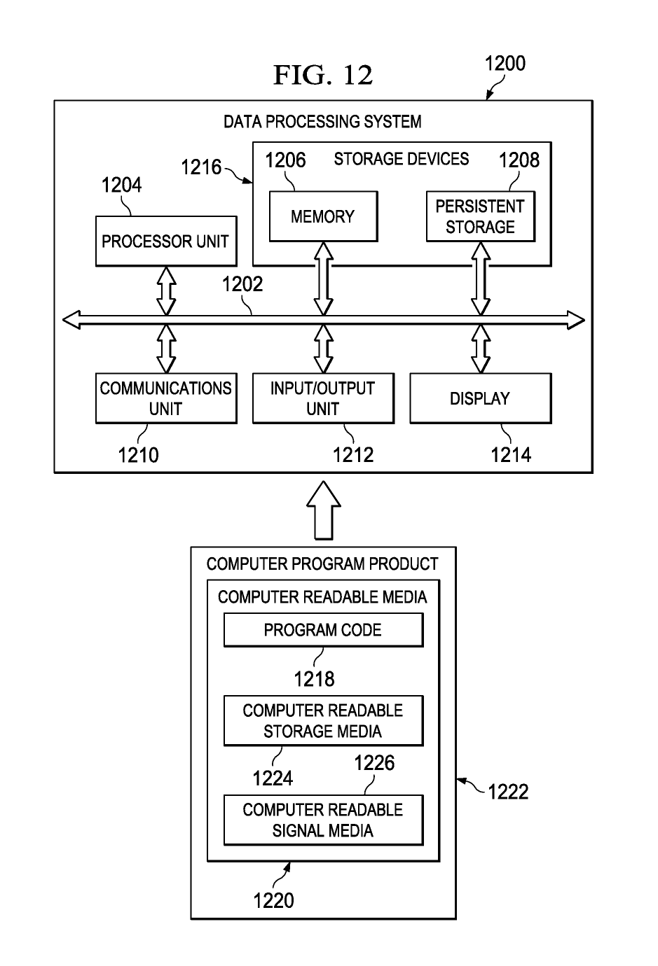

Turning now to FIG. 12, an illustration of a data processing system is depicted in accordance with an advantageous embodiment. Data processing system 1200 may be used to implement one or more computers in testing system 116, data processing hardware 121, and communications hardware 122 shown in block form in FIG. 1. In this illustrative example, data processing system 1200 includes communications framework 1202, which provides communications between processor unit 1204, memory 1206, persistent storage 1208, communications unit 1210, input/output (I/O) unit 1212, and display 1214.

Processor unit 1204 serves to execute instructions for software that may be loaded into memory 1206. Processor unit 1204 may be a number of processors, a multi-processor core, or some other type of processor, depending on the particular implementation. “A number”, as used herein with reference to an item, means one or more items. Further, processor unit 1204 may be implemented using a number of heterogeneous processor systems in which a main processor is present with secondary processors on a single chip. As another illustrative example, processor unit 1204 may be a symmetric multi-processor system containing multiple processors of the same type.

Memory 1206 and persistent storage 1208 are examples of storage devices 1216. A storage device is any piece of hardware that is capable of storing information, such as, for example, without limitation, data, program code in functional form, and other suitable information either on a temporary basis and/or a permanent basis. Storage devices 1216 also may be referred to as computer readable storage devices in these examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208.

Communications unit 1210, in these examples, provides for communications with other data processing systems or devices. In these examples, communications unit 1210 is a network interface card. Communications unit 1210 may provide communications through the use of either or both physical and wireless communications links.

Input/output unit 1212 allows for input and output of data with other devices that may be connected to data processing system 1200. For example, input/output unit 1212 may provide a connection for user input through a keyboard, a mouse, and/or some other suitable input device. Further, input/output unit 1212 may send output to a printer. Display 1214 provides a mechanism to display information to a user.

Instructions for the operating system, applications, and/or programs may be located in storage devices 1216, which are in communication with processor unit 1204 through communications framework 1202. In these illustrative examples, the instructions are in a functional form on persistent storage 1208. These instructions may be loaded into memory 1206 for execution by processor unit 1204. The processes of the different embodiments may be performed by processor unit 1204 using computer implemented instructions, which may be located in a memory, such as memory 1206.

These instructions are referred to as program code, computer usable program code, or computer readable program code that may be read and executed by a processor in processor unit 1204. The program code in the different embodiments may be embodied on different physical or computer readable storage media, such as memory 1206 or persistent storage 1208.

Program code 1218 is located in a functional form on computer readable media 1220 that is selectively removable and may be loaded onto or transferred to data processing system 1200 for execution by processor unit 1204. Program code 1218 and computer readable media 1220 form computer program product 1222 in these examples. In one example, computer readable media 1220 may be computer readable storage media 1224 or computer readable signal media 1226. Computer readable storage media 1224 may include, for example, an optical or magnetic disk that is inserted or placed into a drive or other device that is part of persistent storage 1208 for transfer onto a storage device, such as a hard drive, that is part of persistent storage 1208. Computer readable storage media 1224 also may take the form of a persistent storage, such as a hard drive, a thumb drive, or a flash memory, that is connected to data processing system 1200. In some instances, computer readable storage media 1224 may not be removable from data processing system 1200. In these examples, computer readable storage media 1224 is a physical or tangible storage device used to store program code 1218 rather than a medium that propagates or transmits program code 1218. Computer readable storage media 1224 is also referred to as a computer readable tangible storage device or a computer readable physical storage device. In other words, computer readable storage media 1224 is media that can be touched by a person.

Alternatively, program code 1218 may be transferred to data processing system 1200 using computer readable signal media 1226. Computer readable signal media 1226 may be, for example, a propagated data signal containing program code 1218. For example, computer readable signal media 1226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 1218 may be downloaded over a network to persistent storage 1208 from another device or data processing system through computer readable signal media 1226 for use within data processing system 1200. For instance, a program code stored in a computer readable storage medium in a server data processing system may be downloaded over a network from the server to data processing system 1200. The data processing system providing program code 1218 may be a server computer, a client computer, or some other device capable of storing and transmitting program code 1218.

The different components illustrated for data processing system 1200 are not meant to provide architectural limitations to the manner in which different embodiments may be implemented. The different advantageous embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1204 may take the form of a hardware unit that has circuits that are manufactured or configured for a particular use. This type of hardware may perform operations without needing a program code to be loaded into a memory from a storage device to be configured to perform the operations.

For example, when processor unit 1204 takes the form of a hardware unit, processor unit 1204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1218 may be omitted because the processes for the different embodiments are implemented in a hardware unit.

In still another illustrative example, processor unit 1204 may be implemented using a combination of processors found in computers and hardware units. Processor unit 1204 may have a number of hardware units and a number of processors that are configured to run program code 1218. With this depicted example, some of the processes may be implemented in the number of hardware units, while other processes may be implemented in the number of processors.

In another example, a bus system may be used to implement communications framework 1202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 1206 or a cache, such as found in an interface and memory controller hub that may be present in communications framework 1202.

Thus, one or more of the different advantageous embodiments provide a method and apparatus for testing information transfer with an airport network data processing system. With an advantageous embodiment, connectivity, security, and other parameters may be emulated and tested. With one of the advantageous embodiments, this testing may be performed at the location in which the aircraft is located when communicating with an airport network data processing system. This testing may be performed without actually moving the aircraft to the location with the hardware, software, or a combination thereof to be tested.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A mobile aircraft emulation system comprising:
communications hardware configured for use in an aircraft and to establish a communications link with an airport network data processing system;
data processing hardware configured for use in the aircraft to run a number of software aircraft parts and exchange information with the airport network data processing system using the communications link and wherein the number of software aircraft parts is configured for use in the aircraft.

2. The mobile aircraft emulation system of claim 1, wherein the data processing hardware is configured to perform operations to test functions performed by the aircraft.

3. The mobile aircraft emulation system of claim 2, wherein the operations comprise at least one of sending data, receiving data, authentication with the airport network data processing system, communicating with a maintenance laptop, and loading software aircraft parts to the aircraft from the airport data processing system.

4. The mobile aircraft emulation system of claim 1, wherein the data processing hardware is configured to record results from exchanging the information with the airport network data processing system.

5. The mobile aircraft emulation system of claim 1 further comprising:
a mobile platform configured to carry the communications hardware and the data processing hardware.

6. The mobile aircraft emulation system of claim 5, wherein the mobile platform is selected from one of a cart, a vehicle, a truck, and a suitcase.

7. The mobile aircraft emulation system of claim 1, wherein the communications hardware comprises:
a terminal wireless local area network unit.

8. The mobile aircraft emulation system of claim 1, wherein the communications hardware comprises:
a crew wireless local area network unit.

9. The mobile aircraft emulation system of claim 1, wherein the mobile aircraft emulation system is portable.

10. The mobile aircraft emulation system of claim 1, wherein the communications hardware comprises:
an antenna for the aircraft.

11. The mobile aircraft emulation system of claim 10 further comprising:
a portion of a structure for the aircraft on which the antenna is connected on the aircraft.

12. The mobile aircraft emulation system of claim 10 further comprising:
a positioning system configured to place the antenna in a position that substantially corresponds to a particular position of a corresponding antenna on the aircraft.

13. A mobile communications testing system comprising:
a mobile platform;
a structure carried by the mobile platform and positionable in an orientation substantially similar to when the structure is located on a vehicle;
an antenna connected to the structure such that the antenna has an orientation that substantially corresponds to a particular orientation of a corresponding antenna on the vehicle; and
a hardware system configured for use in the vehicle and to establish a communications link with a network data processing system and emulate information of the vehicle with the network data processing system.

14. The mobile communications testing system of claim 13, wherein the vehicle is selected from one of an aircraft, a surface ship, a tank, a personnel carrier, a train, a spacecraft, a submarine, a bus, and an automobile.

15. A method for testing operations performed with an airport network data processing system, the method comprising:
establishing a communications link between the airport network data processing system and a mobile aircraft emulation system, wherein the mobile aircraft emulation system comprises hardware configured for use in an aircraft that is used for exchanging information with the airport network data processing system;
performing the operations using the communications link in which the operations emulate performance of the operations by the aircraft.

16. The method of claim 15 further comprising:
identifying results from performing the operations using the communications link in which the operations emulate performance of the operations by the aircraft.

17. The method of claim 16, wherein the results are identified passively.

18. The method of claim 16, wherein the operations test functions for at least one of the aircraft and the airport network data processing system.

19. The method of claim 15 further comprising:
placing the mobile aircraft emulation system in a location at an airport in which the airport network data processing system is located.

20. The method of claim 15, wherein the communications link is established using an antenna that has a position that substantially corresponds to a particular position for a corresponding antenna on the aircraft.
